(19) United States
(12) Patent Application Publication
(10) Pub. No.: US 2018/0292988 A1
(43) Pub. Date: Oct. 11, 2018

(54) SYSTEM AND METHOD FOR DATA ACCESS IN A MULTICORE PROCESSING SYSTEM TO REDUCE ACCESSES TO EXTERNAL MEMORY

(71) Applicant: GM GLOBAL TECHNOLOGY OPERATIONS LLC, Detroit, MI (US)

(72) Inventors: SHIGE WANG, NORTHVILLE, MI (US); J. DAVID ROSA, CLARKSTON, MI (US)

(73) Assignee: GM GLOBAL TECHNOLOGY OPERATIONS LLC, Detroit, MI (US)

(21) Appl. No.: 15/482,195

(22) Filed: Apr. 7, 2017

(51) Int. Cl. G06F 3/06; G06F 12/12; G06F 13/16

(52) U.S. Cl. CPC G06F 3/061; G06F 12/12; G06F 3/0604; G06F 3/0631; G06F 2212/69; G06F 3/0653; G06F 3/0683; G06F 13/16; G06F 3/0644

(57) ABSTRACT

A memory access method in a multicore processor integrated circuit (IC) is provided. The method comprises partitioning local memory on the IC into a plurality of memory regions wherein each memory region comprises one or more memory segments and assigning each memory region to one or more processing entities or applications wherein each processing entity comprises a processor core or a processing device that is under the control of a processor core and wherein the application is capable of being performed by one of the processing entities. The method further comprises monitoring, with each processing entity, the usage of each memory segment in each region assigned to the processing entity and assigned to the applications performed by the processing entity and swapping the data in a memory segment from a memory region experiencing a miss for desired data when the miss causes a data access with external memory.

### TECHNICAL FIELD

The technology described in this patent document relates generally to computer systems and more particularly to computers systems having multicore processors that contend for shared memory resources.

### BACKGROUND

Modern vehicles employ various embedded electronic controllers that improve the performance, comfort, safety, etc. of the vehicle. Such controllers include engine controllers, suspension controllers, steering controllers, power train controllers, climate control controllers, infotainment system controllers, chassis system controllers, etc. These controllers may be implemented using multicore processing chips coupled to external memory. A plurality of multicore processing chips may connect by a shared bus to the external memory. In cases of high external memory usage, there may be a high rate of contention between the multicores for access to the shared bus to access the external memory. Large memory access from one core/task may cause significant delay of others, leading to inadequate sharing.

Accordingly, it is desirable to provide a system with improved sharing of the shared memory bus and external memory. Furthermore, other desirable features and characteristics of the present invention will become apparent from the subsequent detailed description of the invention and the appended claims, taken in conjunction with the accompanying drawings and the background of the invention.

### SUMMARY

A memory access system in a multicore processor integrated circuit (IC) is provided. The system includes local memory on the IC partitioned into a plurality of memory regions wherein each memory region includes one or more memory segments, each memory region is assigned to one or more processing entities or applications, each processing entity comprises a processor core or a processing device that is under the control of a processor core, and the application is capable of being performed by one of the processing entities. The system further includes a monitor configured to monitor the usage of each memory segment and a manager configured to manage data swaps in the memory segments wherein a data swap involves the data in a memory segment from a memory region experiencing a miss being swapped for desired data.

A memory access method in a multicore processor integrated circuit (IC) is provided. The method includes partitioning local memory on the integrated circuit into a plurality of memory regions wherein each memory region includes one or more memory segments and assigning each memory region to one or more processing entities or applications wherein each processing entity includes a processor core or a processing device that is under the control of a processor core and wherein the application is capable of being performed by one of the processing entities. The method further includes monitoring, with each processing entity, the usage of each memory segment in each region assigned to the processing entity and assigned to the applications performed by the processing entity and swapping the data in a memory segment from a memory region experiencing a miss for desired data when the miss causes a data access with external memory using an external memory bus.

### BRIEF DESCRIPTION OF THE DRAWINGS

Aspects of the present disclosure are best understood from the following detailed description when read with the accompanying figures, wherein like numerals denote like elements, and

FIG. 1 is a block diagram depicting an example computer system, in accordance with some embodiments;

FIG. 2 is a block diagram depicting another example computer system, in accordance with some embodiments;

FIG. 3 is a block diagram illustrating an example memory partition scheme for local memory, in accordance with some embodiments;

FIG. 4 is a block diagram illustrating an example record in an example data structure for use in recording the dynamic access patterns of different tasks and memory regions, in accordance with some embodiments;

FIG. 5 is a process flow chart depicting an example process for use by an access monitor, in accordance with some embodiments;

FIG. 6 is a process flow chart depicting an example process for use by a partition manager, in accordance with some embodiments; and

FIG. 7 is a process flow chart depicting an example process in a multicore processor for managing memory accesses, in accordance with some embodiments.

### DETAILED DESCRIPTION

The following disclosure provides many different embodiments, or examples, for implementing different features of the provided subject matter. The following detailed description is merely exemplary in nature and is not intended to limit the invention or the application and uses of the invention. Furthermore, there is no intention to be bound by any theory presented in the preceding background or the following detailed description.

The subject matter described herein discloses apparatus, systems, techniques and articles for reducing shared memory access delays in computer systems having multicore processors and local memory. The following disclosure provides many different examples for reducing shared memory access delays by directing more memory accesses to local memory and fewer memory accesses to shared memory. The described examples utilize services such as a memory partition scheme, an access monitor for monitoring local memory accesses, and a partition manager for performing data swaps and dynamically adjusting the memory partition scheme based on monitored local memory access information. The services utilized in these examples can help reduce memory access delays.

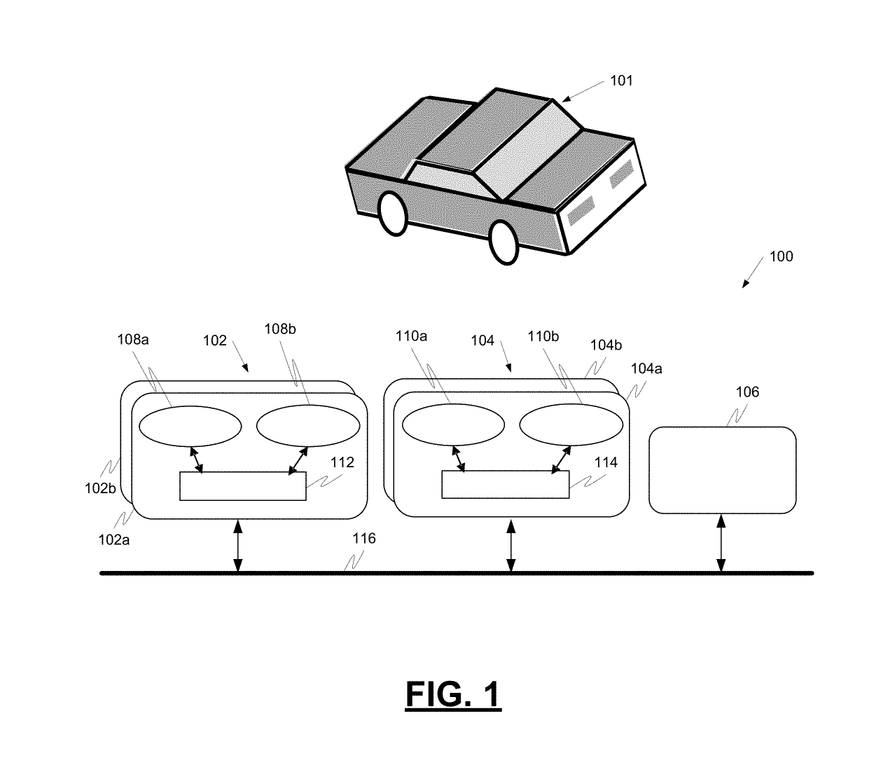

FIG. 1 is a block diagram depicting an example computer system 100. The example computer system 100 may be used to implement a multicore vehicle controller for use in a vehicle 101 such as an automobile. The example computer system 100 includes a first multicore processor 102, a second multicore processor 104, and shared memory 106. Each of the multicore processors 102, 104 contains a plurality of processing entities 102a, 102b, 104a, 104b. Although only two processing entities are shown for each multicore processor 102, 104 in this example, the multicore processors 102, 104 may include many more than two processing entities. In this example, each multicore processor 102, 104 and the shared memory 106 are each on a separate integrated circuit (IC). In another example, the multicore processors 102, 104 may be on the same IC and the shared memory on a different IC. In another example, the multicore processors 102, 104 and the shared memory 106 may be on the same IC as a system on a chip (SOC).

A processing entity may comprise a processor core such as processor core 102a or a processing device under the control of a processor core such as processing device 104a. Examples of a processing device include a graphics processing unit (GPU), a math co-processor, and others. Each of the processing entities have access to local memory and can perform one or more applications. In the illustrated example, the applications performed by the processor core 102a include tasks 108a, 108b, and the applications performed by the processing device 104a include software components 110a, 110b.

To perform their respective applications, the processing entities will attempt to use local memory for data accesses (i.e., data storage and/or retrieval). In this example, the processor core 102a will attempt to use its local memory 112 for data access when performing its tasks 108a, 108b. Similarly, the device 104a will attempt to use its local memory 114 for data access when executing its software components 110a, 110b. In one example the local memory comprises cache memory. In another example, the local memory comprises non-cache memory.

When the local memory is not available for data access due to a miss (i.e., state where the data requested for processing by a processing entity or application is not found in the local memory), the processing entity will attempt to access the shared memory 106 via a shared bus 116. Memory access through the shared bus 116 by different tasks or software components on different cores or devices are made one at a time. A large memory access from one core, device, task, or software component, can delay other cores, devices, tasks, or software components if they are waiting for data access with the shared memory before continuing operation. The apparatus, systems, techniques and articles disclosed herein provide ways to reduce shared memory access delays by directing more memory accesses to local memory and fewer memory accesses to shared memory.

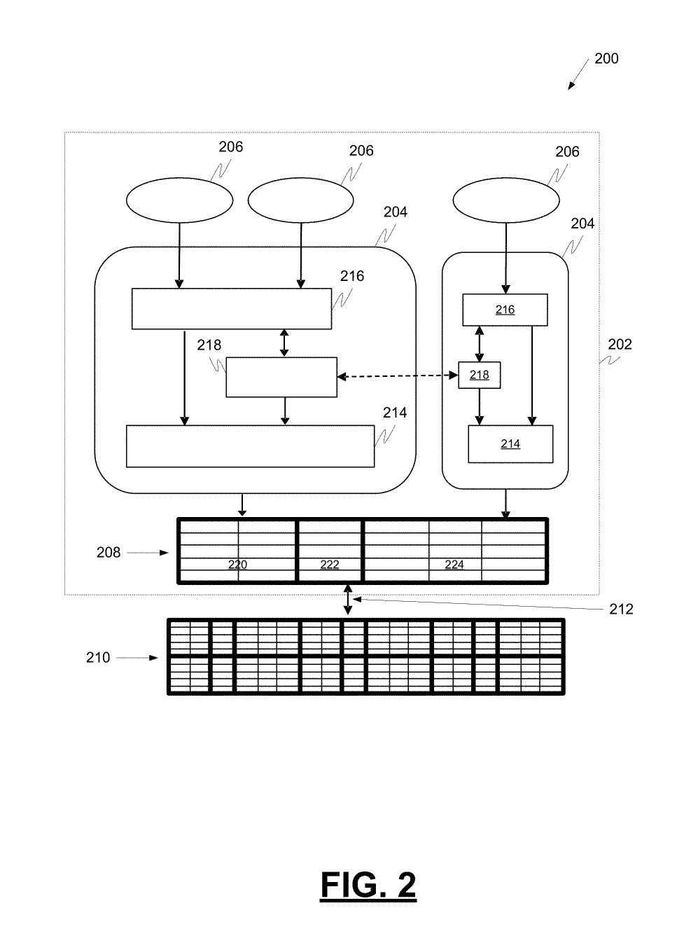

FIG. 2 is a block diagram depicting another example computer system 200. The example computer system 200 may also be used to implement a multicore vehicle controller for use in a vehicle such as an automobile. The example computer system 200 includes a multicore processor 202 comprising a plurality of processing entities 204, applications 206 performed by the processing entities, and local memory 208. Although only two processing entities are shown for the multicore processor 202, in this example, the multicore processor 202 may include many more than two processing entities. The example computer system 200 also includes shared memory 210 that may be shared with other processors (not shown) or other multicore processors (not shown) via a shared bus 212. The local memory 208 may be used by the multicore processor 202 to store a subset of the memory locations of the shared memory 210 to reduce the frequency with which the multicore processor 202 has to access data stored in the shared memory 210.

The example multicore processor 202 directs memory accesses to specific regions of the local memory 208 to reduce shared memory accesses and interferences over the shared memory bus 212. The example multicore processor 202 provides an architecture with services to monitor and manage memory accesses. In particular, the example multicore processor 202 implements a memory organization or partition scheme 214 that differentiates between shared access and private access, a monitor 216 to collect dynamic memory access patterns for different tasks/applications and memory regions (partitions), and a manager 218 to adjust the accessible memory based on the tasks/applications access pattern.

The partition scheme 214 employed in this example, unlike other potential partitions schemes, allows tasks/applications to share data and memory locations. The memory partition scheme 214 is used to divide the local memory into different regions. Implementation of the partition scheme 214 results in the partitioning of the local memory 208 into a number of partitions or memory regions such as a first partition region 220, a second partition region 222, and a third partition region 224, as illustrated in this example. Also, as illustrated, each memory region may include one or more memory segments or pages.

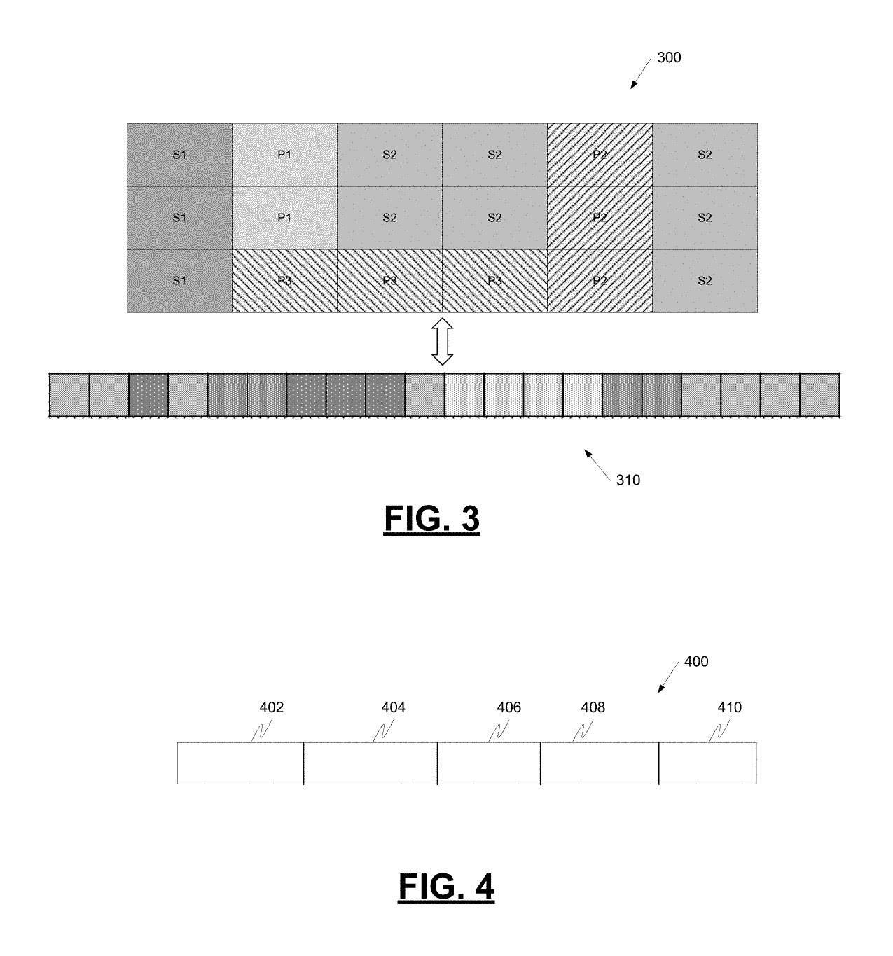

FIG. 3 is a block diagram illustrating an example memory partition scheme for example local memory 300. The example local memory 300 is divided into two shared local memory regions S1, S2 and three private memory regions P1, P2, P3. Each region comprises one or more memory segments or pages. In this example, the first shared memory region S1 is made up of three memory segments, the second shared memory region S2 is made up of seven non-contiguous memory segments, the first private memory region P1 is made up of two memory segments, the second private memory region P2 is made up of three memory segments, and the third private memory region P3 is made up of three memory segments. As illustrated by the second shared memory region S2, the regions do not need to be contiguous within the memory 300. The local memory 300 may be used to store a subset of the memory locations of the shared external memory 310 to reduce the frequency with which the shared external memory 310 is accessed.

The private memory regions P1, P2, P3 are each reserved for use by one application or processing entity. Each private memory region, in this example, is assigned a minimum segment count and a normal segment count. The minimum segment count represents the minimum number of segments that must be maintained in the memory region and the normal segment count represents the number of segments that are normally maintained in the memory region. As discussed below, segments from the private memory regions may be borrowed by shared memory regions. The shared memory regions S1, S2 store data that may be used by multiple processing entities and/or applications.

If data required by an application is not stored in a memory segment in a memory region of the local memory assigned to the application (i.e., a miss in the memory region), the contents of a memory segment in the region in local memory assigned to the application may be swapped with the contents of a memory segment in the shared external memory that has been assigned to the application for data storage (i.e., a data swap). By restricting data swaps to memory segments in the same memory region in which the miss occurred, isolation of the memory regions to their assigned processing entities and/or applications can be maintained.

Dynamic adjustment of the size of a memory region in local memory may also be allowed. As an example, if a memory region experiences a high number of data accesses and data swaps, one or more memory segments may be borrowed or reassigned from a memory region experiencing a low level of data accesses to the memory region experiencing a high number of data accesses and data swaps. By monitoring the number of data accesses in each region, the memory region sizes may be intelligently adjusted based on the memory access patterns and history in the various memory regions. Proper resizing of the memory regions may result in fewer misses to memory regions in the local memory and fewer accesses to the shared external memory. In one example, only the shared memory regions may borrow memory segments. In another example, memory segments may only be borrowed or reassigned from private regions. In another example, memory segment reassignments can only be made from a private memory region to a shared memory region. The reassignment may occur when the access rate and swap rate in the shared memory region is high and the access rate in the private memory region is low.

If the access rate drops substantially in a memory region that had one or more memory segments reassigned to it, a reassigned or borrowed memory segment can be returned to a lending memory region. The returned memory segment may be returned to the memory region that provided the returned memory segment or another lending memory region. Thus, the size of the memory regions may be adjusted dynamically based on computational needs.

The example multicore processor 202 of FIG. 2 implements an example monitor to record the dynamic access patterns of different applications and memory regions (partitions). The example monitor keeps track of the usage of each segment in the local memory regions. The monitoring includes collecting the identity of the task(s) (or application(s)) that access the memory segment, the frequency of access (i.e., the hit rate), and the frequency of swaps (e.g., the miss rate). The monitored information can be used by the partition manager to adaptively tune the assignment of the segments to applications/cores.

The example monitor is made up of a plurality of example monitor units 216, each of which is implemented by a different one of the processing entities. As a result, the monitoring, in this example, is performed by the plurality of example monitor units 216. Each example monitor unit 216 is configured to monitor memory accesses in each memory region assigned to the processing entity that implements the monitor unit 216. Each example monitor unit 216 is also configured to monitor memory accesses in each memory region assigned to the applications performed by the processing entity that implements the monitor unit 216. Each example monitor unit 216 is configured to increment an access count for a memory segment each time data stored in the memory segment is accessed and increment a swap count for the memory segment for each data swap that occurs with the segment. Each example monitor unit 216 is also configured to reset the access count after each data swap. The example monitor and example monitor unit 216 are implemented by the processing entities and configured by programming instructions to record in a data structure a record for each monitored segment. Each record comprises an identifier for the monitored segment, an identifier for the region in which the monitored segment is a part, an application list that includes the identity of any application that accessed data stored in the monitored segment, the access count for the segment, and the swap count for the segment.

FIG. 4 is a block diagram illustrating an example record 400 in an example data structure for recording the dynamic access patterns of different tasks and memory regions. An example monitor records the monitored information for a memory segment in the example record. The example record 400 comprises an identifier 402 for the monitored segment, an identifier 404 for the region in which the monitored segment is a part, an application list 406 that includes the identity of any application that accessed data stored in the monitored segment, the access count 408 for the segment, and the swap count 410 for the segment. Regarding the application list, in this example, only applications that access the partition are recorded, the application list is monotonically grown (i.e., applications are not removed from the list), bit vectors are used for efficient storage and access wherein each bit represents an accessing application, provide a unique representation, and a bit count operation may be used to identify applications that are on the list.

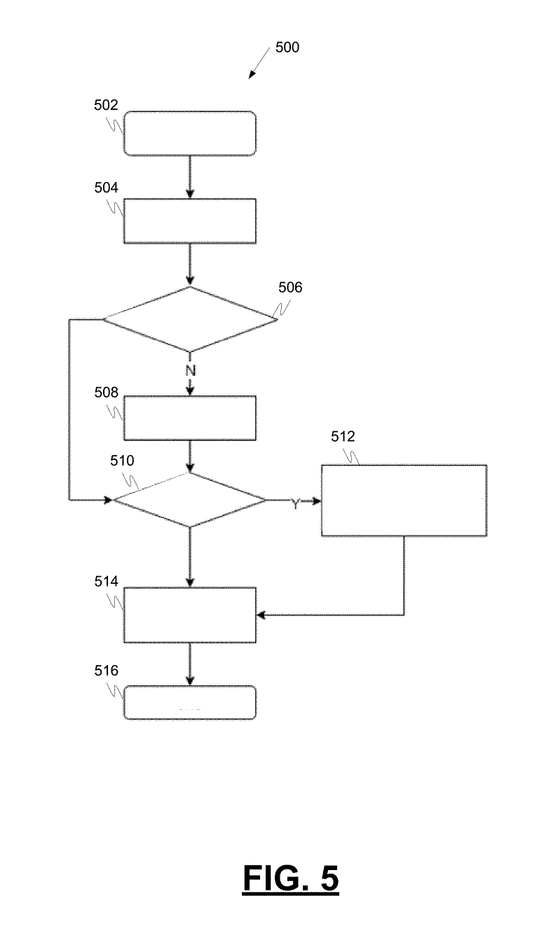

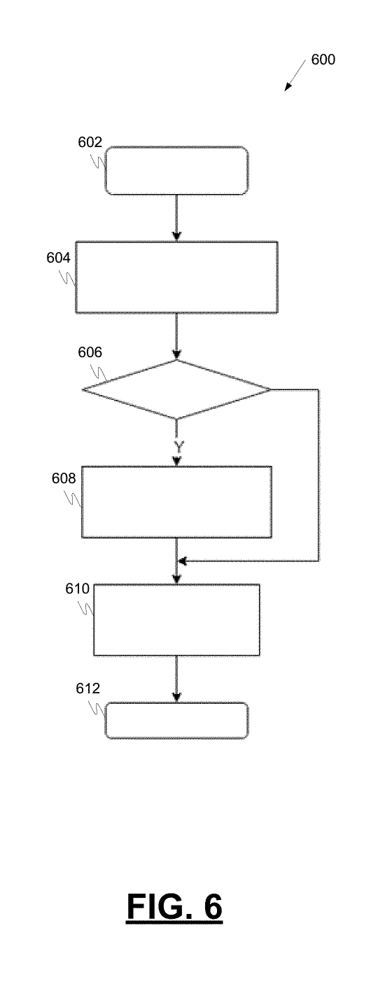

FIG. 5 is a process flow chart depicting an example process 500 for use by an access monitor. A data access request is detected (operation 502), for example, by an example monitor unit 216. The example monitor unit 216 identifies the memory segment (operation 504) that is the destination of the data access request. The example monitor unit 216 makes a decision regarding whether a task (or other application) requesting the data access is on the application list (operation 506). If the requesting task is not on the application list, the task is added to the application list (operation 508). If the requesting task is on the application list or if the task has been added to the application list, a segment swap decision is made (operation 510). If no segment exists that can satisfy the data access request (i.e., segment swap decision is yes), the partition manager can be invoked to swap the contents of a memory segment to allow the memory segment to satisfy the data access request, the example monitor unit 216 can increase the swap count for the swapped segment, and the example monitor unit can reset the access counter for the swapped segment (operation 512). If a segment exists that can satisfy the data access request (i.e., segment swap decision is no), the example monitor unit 216 can increase the access counter for the memory segment (operation 514). The process ends (operation 516).

The example multicore processor 202 of FIG. 2 also implements an example partition manager to adjust the memory segments and memory partitions based on the memory segment access pattern. The example partition manager can adjust a segment by swapping data in the segment when a data access miss in a memory partition region is detected. When the data access miss is detected, the manager is invoked. The example manager swaps data in a memory segment that is in the same memory region in which the data access miss occurred.

In one example, the following swap policy is implemented. The memory segment selected for the swap will be the memory segment in same partition that has the lowest access count. If more than one segments tie for the lowest access count, then the tied segment with the smallest task list may be selected.

The example partition manager can also resize memory regions by reassigning one or more memory segments. The example manager can increase the size of a region when the access count and swap count in the region are high, and decreases the size of a region when the access count in the region is low. As an example, a partition manager can reassign a memory segment from a first region to a second region when the access count and the swap count in the second region are above a first threshold level (e.g., high relative to the counts in other regions or a fixed set level), the access count in the first region is below a second threshold level (e.g., low relative to the counts in other regions or a fixed level), and the access count for the memory segment to be reassigned is at or below a third threshold level (e.g., zero).

In one example, the following resize policy is implemented. Only shared partitions may borrow or have memory segments reassigned to them. The borrowed or reassigned memory segments come from private partitions. A shared partition may have its partition size increased when its swap count is higher than a threshold. The private partition with the lowest access count would be chosen for providing the reassigned memory segment. In case of a tie between two or more private partitions, the private partition with the least important task/assignment would be chosen for providing the reassigned memory segment. When the access count for the reassigned memory segment decreases to zero for a predefined duration of time, the reassigned memory segment is returned to its original memory region.

The example partition manager is implemented by the processing entities and configured by programming instructions. The example partition manager is also made up of a plurality of partition manager units 218, each of which is implemented by a different one of the processing entities.

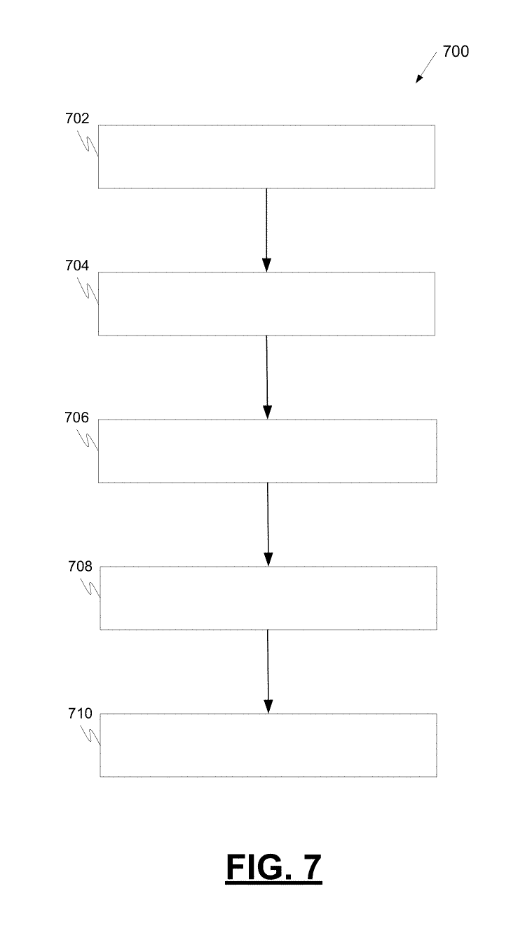

FIG. 6 is a process flow chart depicting an example process 600 for use by a partition manager. A segment swap request is generated (operation 602). The partition manager identifies a replacement segment according to its swap policy (operation 604). The partition manager makes a resize determination based on monitored access information (operation 606). If the partition manager determines that a partition needs to be resized, the partition manager adjusts the size of the partition according to its resize policy (operation 608). If the partition manager determines that resize is not necessary or has adjusted the size of the partition, the partition manager updates the partition by assigning to it a new segment (operation 610). The process ends (operation 612).

FIG. 7 is a process flow chart depicting an example process 700 in a multicore processor for managing memory accesses. Local memory on an integrated circuit in partitioned into a plurality of memory regions (operation 702). Partitioning the local memory may also involve partitioning the local memory into a plurality of private and shared memory regions. Each memory region may have one or more memory segments.

Each memory region is assigned to one or more processing entities or applications (operation 704). A processing entity may be a processor core or a device that is under the control of a processor core. The application may be a task or a software component. Assigning may involve assigning each private region to a single processing entity or application and assigning each shared region to a plurality of processing entities and/or applications.

The usage of each memory segment in each region is monitored (operation 706). The monitoring may be performed by a plurality of monitor units wherein each monitor unit is implemented by one of the processing entities. Each monitor unit may be configured to monitor memory accesses in each memory region assigned to the processing entity that implements the monitor unit and assigned to the applications performed by the processing entity. Usage monitoring may involve monitoring hits to the memory segments, data swaps in memory segments, and misses to memory regions. In one example, monitoring the usage involves incrementing an access count for the memory segment each time data stored in the memory segment is accessed and incrementing a swap count for the memory segment for each data swap that occurs with the segment. Monitoring the usage may also involve resetting the access count after each data swap. The individual monitor units can be configured to increment the access count for a memory segment each time data stored in the memory segment is accessed and increment the swap count for the memory segment for each data swap that occurs with the segment. The monitor units can also be configured to reset the access count after each data swap. In another example, monitoring the usage may involve recording in a data structure a record for each monitored segment wherein each record comprises an identifier for the monitored segment, an identifier for the region of which the monitored segment is a part, an application list that includes the identity of any application that accessed data stored in the monitored segment, the access count for the segment, and the swap count for the segment.

Data in a memory segment may be swapped for desired data in response to a miss to the local memory (operation 708). A partition manager may manage data swaps in the memory segments. A data swap involves the data in a memory segment from a memory region experiencing a miss being swapped for desired data. In one example, the memory segment selected for the swap will be the memory segment in same partition that has the lowest access count. If more than one segments tie for the lowest access count, then the tied segment with the smallest task list can be selected.

Partitions can be resized by assigning a memory segment to a different partition region based on certain monitored conditions (operation 710). In one example, a memory segment is reassigned from a first region to a second region when the access count and swap count in the second region are above a first threshold level (e.g., high relative to the counts in other regions), the access count in the first region is below a second threshold level (e.g., low relative to the counts in other regions), and the access count for the memory segment to be reassigned is at or below a third threshold level (e.g., zero).

Described herein are apparatus, systems, techniques and articles for reducing shared memory access delays in computer systems with multicore processors and local memory by directing more memory accesses to local memory and fewer memory accesses to the shared memory. The apparatus, systems, techniques and articles for reducing the number of accesses to shared memory may involve one or more of a memory partition scheme, an access monitor for monitoring local memory accesses, and a partition manager for performing data swaps and dynamically adjusting the memory partition scheme based on monitored local memory access information.

In one embodiment, a memory access method in a multicore processor integrated circuit (IC) is provided. The method comprises partitioning local memory on the integrated circuit into a plurality of memory regions wherein each memory region comprises one or more memory segments and assigning each memory region to one or more processing entities or applications wherein each processing entity comprises a processor core or a processing device that is under the control of a processor core and wherein the application is capable of being performed by one of the processing entities. The method further comprises monitoring, with each processing entity, the usage of each memory segment in each region assigned to the processing entity and assigned to the applications performed by the processing entity and swapping the data in a memory segment from a memory region experiencing a miss for desired data when the miss causes a data access with external memory using an external memory bus.

These aspects and other embodiments may include one or more of the following features. Partitioning the local memory may comprise partitioning the local memory into a plurality of private and shared memory regions. Assigning each memory region may comprise assigning each private region to a single processing entity or application and assigning each shared region to a plurality of processing entities or applications. Monitoring the usage may comprise incrementing an access count for the memory segment each time data stored in the memory segment is accessed and incrementing a swap count for the memory segment for each data swap that occurs with the segment. The method may further comprise resetting the access count after each data swap. The method may further comprise determining the access count and the swap count in each region by summing the access counts and swap counts for each segment in the region and reassigning a memory segment from a first region to a second region when the access count and swap count in the second region are above a first threshold level, the access count in the first region is below a second threshold level, and the access count for the memory segment to be reassigned is at or below a third threshold level. Monitoring the usage may further comprise recording in a data structure a record for each monitored segment wherein each record comprises an identifier for the monitored segment, an identifier for the region in which the monitored segment is a part, an application list that includes the identity of any application that accessed data stored in the monitored segment, the access count for the segment, and the swap count for the segment.

In another embodiment, a memory access system in a multicore processor integrated circuit (IC) is provided. The system comprises local memory on the IC partitioned into a plurality of memory regions wherein each memory region comprises one or more memory segments, each memory region is assigned to one or more processing entities or applications, each processing entity comprises a processor core or a processing device that is under the control of a processor core, and the application is capable of being performed by one of the processing entities. The system further comprises a monitor configured to monitor the usage of each memory segment and a manager configured to manage data swaps in the memory segments wherein a data swap involves the data in a memory segment from a memory region experiencing a miss being swapped for desired data.

These aspects and other embodiments may include one or more of the following features. The memory regions may comprise one or more private memory regions and one or more shared memory regions wherein each private region may be assigned to a single processing entity or application and each shared region may be assigned to a plurality of processing entities or applications. The monitor may comprise a plurality of monitor units wherein each monitor unit is implemented by one of the processing entities and each monitor unit is configured to monitor memory accesses in each memory region assigned to the processing entity that implements the monitor unit and assigned to the applications performed by the processing entity. Each monitor unit may be configured to increment an access count for a memory segment each time data stored in the memory segment is accessed and increment a swap count for the memory segment for each data swap that occurs with the segment. The monitor may be configured to determine the access count and the swap count in each region by summing the access counts and swap counts for each segment in the region and the manager may be configured to reassign a memory segment from a first region to a second region when the access count and the swap count in the second region are above a first threshold level, the access count in the first region is below a second threshold level, and the access count for the memory segment to be reassigned is at or below a third threshold level. The first region may be a private region and the second region may be a shared region. The manager may be configured to return the reassigned memory segment from the second region to the first region when the access count in the second region drops below a fourth threshold level for a period of time. The monitor may be further configured to record in a data structure a record for each monitored segment wherein each record comprises an identifier for the monitored segment, an identifier for the region in which the monitored segment is a part, an application list that includes the identity of any application that accessed data stored in the monitored segment, the access count for the segment, and the swap count for the segment. The monitor may be implemented by one or more of the processing entities and configured by first programming instructions and the manager may be implemented by one or more of the processing entities and configured by second programming instructions.

In another embodiment, a multicore vehicle controller is provided. The multicore vehicle controller comprises a plurality of processor cores on an integrated circuit. The processor cores are configured to assign each memory region in partitioned local memory residing on the IC to one or more processor cores or executable applications wherein each memory region comprises one or more memory segments. The processor cores are further configured to increment, for each memory segment, an access count for the memory segment each time data stored in the memory segment is accessed and increment a swap count for the memory segment for each data swap that occurs with the segment, select a memory segment from a memory region experiencing a miss for a data swap wherein the selected memory segment has the lowest access count of all the memory segments in the memory region, and swap the data in the selected memory segment for desired data when the miss causes a data access with external memory using an external memory bus.

These aspects and other embodiments may include one or more of the following features. The partitioned local memory may comprise a plurality of private and shared memory regions wherein each private region is assigned to a single processing entity or application, each private region is assigned a minimum segment count representing the minimum number of segments for the region, and each shared region is assigned to a plurality of processing entities or applications. The processor cores may be further configured to determine the access count and the swap count in each region by summing the access counts and swap counts for each segment in the region, further configured to select a memory segment for reassignment from a first region to a second region, and further configured to reassign the memory segment selected for reassignment to the second region when the access count and swap count in the second region are above a first threshold level, the access count in the first region is below a second threshold level, and the access count for the memory segment selected for reassignment is at or below a third threshold level. The first region may be a private region, the second region may be a shared region, and the first region may comprise a number of segments greater than the minimum segment count for the region.

In another embodiment, provided is a data access method in an integrated circuit having multiple processing entities, local memory, and an external memory bus wherein each processing entity is capable of executing an application and comprises a processor core or a processing device under the control of a processor core and wherein the application comprises a task or a software component and each processor core is capable of performing a task and each processing device is capable of executing a software component. The method comprises partitioning the local memory into a plurality of private and shared memory regions wherein each memory region comprises one or more memory segments, assigning each private region to a single processing entity or application and assigning each shared region to a plurality of processing entities or applications, and monitoring, with each processing entity, the usage of each memory segment in each region assigned to the processing entity and assigned to the applications performed by the processing entity. The method further comprises incrementing an access count for the memory segment each time data stored in the memory segment is accessed, incrementing a swap count for the memory segment for each data swap that occurs with the segment, and resetting the access count after each data swap. The method further comprises recording in a data structure a record for each monitored segment wherein each record comprises an identifier for the monitored segment, an identifier for the region in which the monitored segment is a part, an application list that includes the identity of any application that accessed data stored in the monitored segment, the access count for the segment, and the swap count for the segment. The method further comprises swapping the data in a memory segment from a memory region experiencing a miss for desired data when the miss causes a data access with external memory using an external memory bus, determining the access count and the swap count in each region by summing the access counts and swap counts for each segment in the region, and reassigning a memory segment from a first region to a second region when the access count and swap count in the second region are above a first threshold level, the access count in the first region is below a second threshold level, and the access count for the memory segment to be reassigned is at or below a third threshold level.

In another embodiment, a method in a multicore integrated circuit having multiple processor cores, local memory, and an external memory bus is provided. The method comprises providing on an integrated circuit (IC) a plurality of processing units, local memory accessible by the plurality of processing units, and an external memory bus accessible by the plurality of processing units wherein each processing unit comprises a processor core or a processing device. The method further comprises providing infrastructure services for each processing unit to monitor and manage accesses wherein the infrastructure services include a memory partition scheme to differentiate shared access and private access, an access monitor to collect dynamic access patterns of different tasks and memory regions, and a partition manager to adjust the accessible memory according to access patterns. The method further comprises partitioning the local memory into different regions in accordance with the memory partition scheme wherein the different regions comprise one or more private regions and one or more shared regions. The private regions are reserved for use by a specific component wherein a specific component is a specific core, a specific task executable by a specific core, a specific device, or a specific software component executable by a specific device. The shared regions are reserved for use by one or more components, cores, tasks, or software components. The method further comprises monitoring usage of each segment in the regions using the access monitor and adjusting the segments using the partition manager.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory access method in a multicore processor integrated circuit (IC), the method comprising:
partitioning local memory on the integrated circuit into a plurality of memory regions, each memory region comprising one or more memory segments;
assigning each memory region to one or more processing entities or applications, each processing entity comprising a processor core or a processing device that is under the control of a processor core, the application capable of being performed by one of the processing entities;
with each processing entity, monitoring the usage of each memory segment in each region assigned to the processing entity and assigned to the applications performed by the processing entity; and
swapping the data in a memory segment from a memory region experiencing a miss for desired data when the miss causes a data access with external memory using an external memory bus.

2. The method of claim 1 wherein partitioning the local memory comprises partitioning the local memory into a plurality of private and shared memory regions.

3. The method of claim 2 wherein assigning each memory region comprises assigning each private region to a single processing entity or application and assigning each shared region to a plurality of processing entities or applications.

4. The method of claim 1 wherein monitoring the usage comprises incrementing an access count for the memory segment each time data stored in the memory segment is accessed and incrementing a swap count for the memory segment for each data swap that occurs with the segment.

5. The method of claim 4 further comprising resetting the access count after each data swap.

6. The method of claim 4 further comprising:
determining the access count and the swap count in each region by summing the access counts and swap counts for each segment in the region; and
reassigning a memory segment from a first region to a second region when the access count and swap count in the second region are above a first threshold level, the access count in the first region is below a second threshold level, and the access count for the memory segment to be reassigned is at or below a third threshold level.

7. The method of claim 4 wherein monitoring the usage further comprises recording in a data structure a record for each monitored segment, each record comprising an identifier for the monitored segment, an identifier for the region in which the monitored segment is a part, an application list that includes the identity of any application that accessed data stored in the monitored segment, the access count for the segment, and the swap count for the segment.

8. A memory access system in a multicore processor integrated circuit (IC), the system comprising:
local memory on the IC partitioned into a plurality of memory regions, each memory region comprising one or more memory segments, each memory region assigned to one or more processing entities or applications, each processing entity comprising a processor core or a processing device that is under the control of a processor core, the application capable of being performed by one of the processing entities;
a monitor configured to monitor the usage of each memory segment; and
a manager configured to manage data swaps in the memory segments, a data swap involving the data in a memory segment from a memory region experiencing a miss being swapped for desired data.

9. The system of claim 8 wherein the memory regions comprise one or more private memory regions and one or more shared memory regions and wherein each private region is assigned to a single processing entity or application and each shared region is assigned to a plurality of processing entities or applications.

10. The system of claim 9 wherein the monitor comprises a plurality of monitor units, each monitor unit implemented by one of the processing entities, each monitor unit configured to monitor memory accesses in each memory region assigned to the processing entity that implements the monitor unit and assigned to the applications performed by the processing entity.

11. The system of claim 10 wherein each monitor unit is configured to increment an access count for a memory segment each time data stored in the memory segment is accessed and increment a swap count for the memory segment for each data swap that occurs with the segment.

12. The system of claim 11 wherein:
the monitor is configured to determine the access count and the swap count in each region by summing the access counts and swap counts for each segment in the region; and
the manager is configured to reassign a memory segment from a first region to a second region when the access count and the swap count in the second region are above a first threshold level, the access count in the first region is below a second threshold level, and the access count for the memory segment to be reassigned is at or below a third threshold level.

13. The system of claim 12 wherein the first region is a private region and the second region is a shared region.

14. The system of claim 13 wherein the manager is configured to return the reassigned memory segment from the second region to the first region when the access count in the second region drops below a fourth threshold level for a period of time.

15. The system of claim 12 wherein the monitor is further configured to record in a data structure a record for each monitored segment, each record comprising an identifier for the monitored segment, an identifier for the region in which the monitored segment is a part, an application list that includes the identity of any application that accessed data stored in the monitored segment, the access count for the segment, and the swap count for the segment.

16. The system of claim 8 wherein the monitor is implemented by one or more of the processing entities and configured by first programming instructions and the manager is implemented by one or more of the processing entities and configured by second programming instructions.

17. A multicore vehicle controller comprising a plurality of processor cores on an integrated circuit (IC), the processor cores configured to:
assign each memory region in partitioned local memory residing on the IC to one or more processor cores or executable applications, each memory region comprising one or more memory segments;
for each memory segment, increment an access count for the memory segment each time data stored in the memory segment is accessed and increment a swap count for the memory segment for each data swap that occurs with the segment;
select a memory segment from a memory region experiencing a miss for a data swap, the selected memory segment having the lowest access count of all the memory segments in the memory region; and
swap the data in the selected memory segment for desired data when the miss causes a data access with external memory using an external memory bus.

18. The controller of claim 17 wherein the partitioned local memory comprises a plurality of private and shared memory regions and wherein each private region is assigned to a single processing entity or application, each private region is assigned a minimum segment count representing the minimum number of segments for the region, and each shared region is assigned to a plurality of processing entities or applications.

19. The controller of claim 18 wherein the processor cores are further configured to:
determine the access count and the swap count in each region by summing the access counts and swap counts for each segment in the region;
select a memory segment for reassignment from a first region to a second region; and
reassign the memory segment selected for reassignment to the second region when the access count and swap count in the second region are above a first threshold level, the access count in the first region is below a second threshold level, and the access count for the memory segment selected for reassignment is at or below a third threshold level.

20. The controller of claim 19 wherein the first region is a private region, the second region is a shared region, and the first region comprises a number of segments greater than the minimum segment count for the region.
